(19) United States
(12) Patent Application Publication
(10) Pub. No.: US 2009/0155752 A1
(43) Pub. Date: Jun. 18, 2009

(54) Non-right justification display system and method for displaying arithmetic equations

(76) Inventor: Charles Pillsbury Resor, Wilson, WY (US)

Correspondence Address: HUSCH BLACKWELL SANDERS LLP, 190 CARONDELET PLAZA, SUITE 600, ST. LOUIS, MO, 63105-3441, US

(21) Appl. No.: 11/024,156

(22) Filed: Dec. 22, 2004

Related U.S. Application Data
(63) Continuation-in-part of application No. 10/083,455, filed on Feb. 26, 2002, now abandoned.

(51) Int. Cl. G09B 5/00; G06F 3/00; G09B 19/00

(52) U.S. Cl. 434/201; 708/170

(57) ABSTRACT

Display system and method for visually displaying arithmetic equations in a non-right justified manner. A first set of one or more arrays displays a first operand, a second set displays a second operand, and a third set displays a numeral. The numeral typically represents an answer to the equation. The display of at least one of the first operand, the second operand, or the numeral can be non-right justified. When non-right justification occurs, the array set corresponding to the non-right justified operand or numeral includes at least one more array than is required to display the operand or numeral, and at least one array to the right of that operand or numeral is left inactive.

### CROSS-REFERENCES TO RELATED APPLICATIONS

This application is a continuation-in-part of U.S. application Ser. No. 10/083,455, filed Feb. 26, 2002, the disclosure of which is incorporated herein by reference.

### STATEMENT REGARDING FEDERALLY SPONSORED RESEARCH OR DEVELOPMENT

Not applicable.

### BACKGROUND OF THE INVENTION

1. Field of the Invention

This invention relates to an electronic display device and method for displaying arithmetic equations in an essentially horizontal format in digit-dedicated arrays and, specifically, to such a device and method that display portions of the equations (e.g., either or both operands, and/or the answer) in a non-right justified manner.

2. Prior Art

Numerous liquid-crystal displays and other electronically-actuated displays are known for displaying equations, either for calculating purposes or for use as a learning aid for students. Devices of this kind typically have a fixed set of horizontally-arranged arrays for displaying the operands and the answer, display each digit of the operands and the answer with a separate array, and are programmed to use the arrays which will result in the right justification of the operands and the answer.

For example, the device sold under the trade designation Texas Instruments Math . . . To Go! electronic learning aid has a liquid crystal display designed as follows: 188*88=888 (the “*” representing a special multisegment array capable of displaying a representation of an addition, subtraction, multiplication, or division symbol). That is, the “Math . . . To Go” device uses three arrays for the left operand, two for the right operand, and three for the answer. Each of the eight arrays, except the leftmost, is composed of seven segments in the conventional manner so as to be capable of displaying an appropriate digit of the operand or answer. The leftmost array is composed of two vertically-aligned segments since it needs to be capable of displaying only the digit “1”. To display 4×2=8, for example, the “Math . . . to Go” device right justifies each of the equation's three terms by leaving blank the two leftmost arrays for the left operand, the leftmost array for the right operand, and the two leftmost arrays for the answer resulting in: _{—}_{—}4×_{—}2=_{—}_{—}8 (each “_” representing a blank array). As discussed below, this particular display of the characters in the equation could be improved.

Other prior art examples are the very similar devices sold under the trade designations Skillmaster or Drillmaster by Educational Insights. Although these devices apparently use light-emitting diode (LED) technology, they suffer from the same issue identified above. The display of these devices is designed as follows: 88*8=88. That is, each of the devices uses five seven-segment arrays for displaying digits: two arrays for the left operand, one for the right operand, and two for the answer. To display 4×2=8, it right justifies the three terms by leaving blank the leftmost array for the left operand and the leftmost array for the answer resulting in: _{—}4×2=_{—}8. As will be explained, this particular display scheme could be improved.

Displays of this conventional type (always right justified) often present equations in a visually unbalanced format that is different from what students are accustomed to seeing in other media, such as books, worksheets, and the blackboard. For instance, in the cases of Math . . . to Go and the Skillmaster devices, _{—}_{—}4×_{—}2=_{—}8_ and _{—}4×2=8_, respectively, would be more normal display formats for the equation 4×2=8 than the right-justified formats used by the devices. The always right justified manner of display could be a source of confusion for students and, probably more significantly, the unbalanced display of equations is less pleasing to the eye and more likely to cause visual and mental fatigue, thereby resulting in less efficacious and less frequent use of the devices in question. Moreover, in attempting to commit to memory a basic arithmetic math fact (equation), such as 4×2=8, a student will sometimes find it helpful to form a mental visual image of the math fact. But if a device presents the problem (4×2=?) and the math fact (4×2=8) in a visually abnormal format, the device does not as effectively reinforce the student's mental image of the math fact as it would using a more normal format.

Examples of patents that describe prior art devices are: U.S. Pat. No. 4,340,374, issued Jul. 20, 1982 to Culley; U.S. Pat. No. 4,447,213 issued May 8, 1984 to Culley; and U.S. Pat. No. 4,040,048, issued Aug. 2, 1977 to Lien.

There are other types of displays, such as dot matrix displays, that provide much more flexibility in placement of the operands and answer. In fact, they also provide flexibility in placement of all elements of the equations, including the operator(s) and the equal sign. Such a display is shown in U.S. Pat. No. 5,067,102, issued Nov. 19, 1991 to Eisenstein. Such displays give a more natural, balanced and printed look to the equation. Unfortunately, such displays and the microprocessors that control them are significantly more expensive than displays and control circuits using conventional seven-segment arrays, especially if the size, clarity and contrast of the numbers displayed are comparable. Expense is a particular problem when the display is incorporated into a learning device for use by elementary-school children. In that situation, it is desirable that the device be sufficiently affordable for each student to have one exclusively available to such student when the class is using them, especially if the device teaches only fundamental arithmetic. Displays in these devices commonly use non-dot-matrix LCD or LED technology, although the present invention is not limited to liquid crystal displays or light emitting diode displays.

### BRIEF SUMMARY OF THE INVENTION

In a first aspect of the present invention, a method is provided for visually representing arithmetic equations on a display, one at a time. Each equation includes (a) a left operand having at least one digit, (b) an arithmetic operator located to the right of the left operand, (c) a right operand located to the right of the operator and having at least one digit, (d) an equal symbol located to the right of the right operand, and (e) a numeral located to the right of the equal symbol, which numeral includes at least one digit and represents a sum, a difference, a product, or a quotient. The arithmetic operator can be an addition symbol, a subtraction symbol, a multiplication symbol, or a division symbol. (Of course, specialized devices—such as those that only teach multiplication—would use only a multiplication symbol, and still fit within the scope of the present invention.) The left operand, the right operand, and the numeral each constitute a term of an equation to be displayed. The method includes displaying simultaneously at least one digit of the left operand in a first set of one or more separate arrays, at least one digit of the right operand in a second set of one or more separate arrays, and at least one digit of the numeral in a third set of separate arrays. Each array is located in a separate fixed position on the display essentially horizontally to the left or right of each other array. In each set of arrays, at least one array has at least seven electronically operable segments, each segment being visually continuous, at least two of the segments for each array being elongate and oriented in substantially different directions. At least one of the sets of arrays includes at least two of such arrays having at least seven segments so as to display at least two digits side by side. For at least a first equation, a rightmost digit of one of the terms is displayed by means of an array having at least seven segments, which array is used for a different, second equation to display a second-to-rightmost digit of the corresponding term of the second equation, the term in the second equation comprising at least one more digit than the corresponding term in the first equation.

In a second aspect of the present invention, a display is provided for visually representing arithmetic equations, one at a time. The equations have the features set forth immediately above. The display includes first, second, and third sets of segmented arrays. At least one digit of the left operand is displayed in the first set of one or more arrays, at least one digit of the right operand is displayed in the second set of one or more arrays, and at least one digit of the numeral is displayed in the third set of arrays. Each array is located in a separate fixed position on the display essentially horizontally to the left or right of each other array. In each set of arrays, at least one array has at least seven electronically operable segments, each segment being visually continuous, at least two of the segments for each array being elongate and oriented in substantially different directions. At least one of the sets of arrays includes at least two of such arrays having at least seven segments so as to display at least two digits side by side. For at least a first equation, a rightmost digit of one of the terms is displayed by means of an array having at least seven segments, which array is used for a different, second equation to display a second-to-rightmost digit of the corresponding term of the second equation, the term in the second equation comprising at least one more digit than the corresponding term in the first equation.

Among the various objects and features of the present invention are the provision of:
A display and method for displaying arithmetic equations in a more natural format.
A display and method for displaying arithmetic equations in a format that is less confusing to young children.
A display and method for displaying arithmetic equations in a format that is less visually and/or mentally fatiguing.
A display and method for displaying arithmetic equations that is relatively inexpensive, and therefore suitable for classroom use.
A display and method for displaying arithmetic equations that uses segmented display arrays, but displays equations with such arrays in an improved format.
A display and method for displaying arithmetic equations that can non-right justify at least one of the left operand, the right operand, or the answer.
A display and method for displaying arithmetic equations that can non-right justify at least two of the left operand, the right operand, and the answer.
A display and method for displaying with electronically-operable, digit-dedicated arrays two-operand, horizontally-formatted arithmetic equations one equation at a time with one or more of the equation's operands and answer sometimes being displayed in a non-right justified manner such that all of the above-described disadvantages associated with prior art are substantially mitigated, eliminated or avoided.
A display and method for displaying, with high contrast and clarity on an inexpensive child-portable device by means of electronically-operable digit-dedicated arrays, two-operand arithmetic equations in a horizontal format where one or more digits included in an equation are sometimes not located in the rightmost possible array(s), resulting in all the equation's digits being spaced relative to one another and to the equation's arithmetic operator and equal symbol so that the equation is closer to being visually balanced as it would be in a conventional printed format.
Other objects and features will become apparent from consideration of the ensuing description and drawings.

### BRIEF DESCRIPTION OF THE DRAWINGS

FIG. 1 shows an exterior top view of an inexpensive, young-child-portable, battery-powered electronic learning aid for teaching arithmetic skills, incorporating the display and method of the present invention.

FIG. 2 shows an enlarged graphic layout of a liquid crystal display (LCD) for the learning aid of FIG. 1.

FIG. 3 shows a block diagram of the components of the learning aid of FIG. 1.

FIG. 4 is a top view of an alternative electronic learning aid that teaches or calculates basic arithmetic tables (math facts) and that uses the display and method of the present invention.

Similar reference characters indicate similar parts throughout the several views of the drawings.

### DETAILED DESCRIPTION OF THE INVENTION

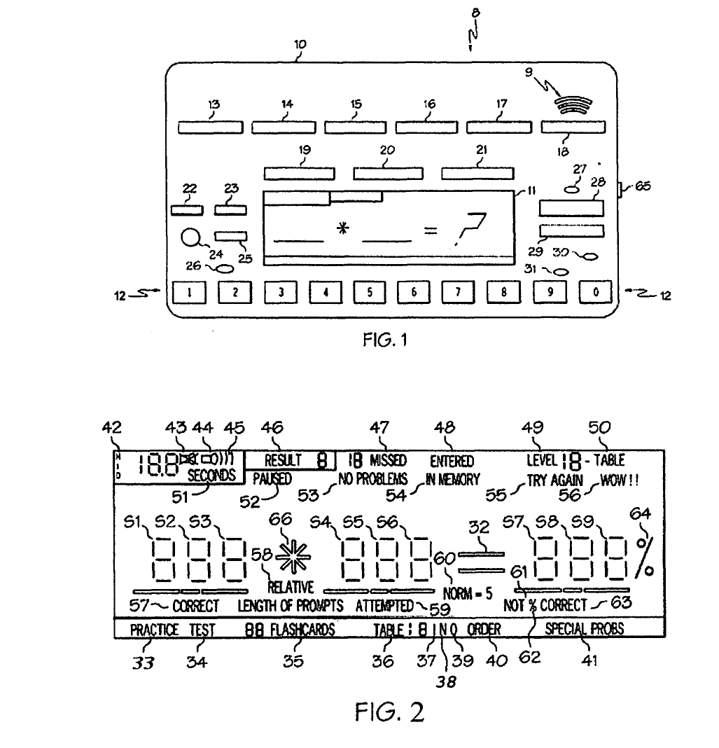

FIG. 1 shows the top of an inexpensive, portable, battery-powered electronic learning aid 8 for teaching arithmetic skills to students as young as seven years old. The learning aid comprises a case 10 which houses the device's electronic components. The learning aid 8 is described in detail in U.S. application Ser. No. 10/083,455, the disclosure of which is incorporated herein by reference. The case 10 is of a suitable size and shape for use by young students. As will become apparent, hereinafter, the present invention is not limited to such learning aids.

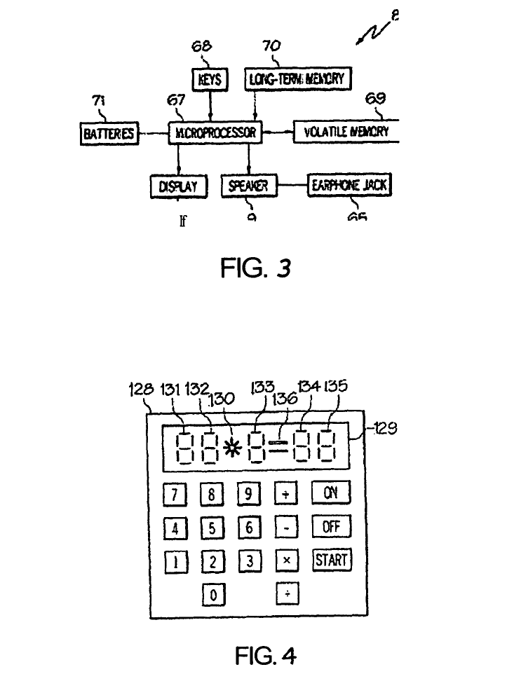

On the exterior of case 10, in communication with the electronics of the interior (electronics are graphically indicated in FIG. 3), is a display 11 of the present invention for visual communication of problems and other information to a user. Display 11 is a liquid crystal display (LCD) or other suitable segmented array-type display (as described below), including a LED display or a combination LED/LCD display meeting the segmented requirements of the claims. A common example of a segmented array-type display in this context is a conventional display made up of a plurality of seven-segment arrays. Nor is the present invention limited to the precise display shown in FIG. 1. As will be seen hereinafter, displays that are much simpler than that shown in FIG. 1 may still incorporate the present invention.

Display 11 (see FIG. 2) includes a multi-segment array 66 for visually representing either: an addition symbol, a subtraction symbol, a multiplication symbol, or a division symbol, one symbol at a time, or a combination of the components of all four symbols (composite operator). Alternatively, other conventional array elements could be used as the operator array 66.

In the preferred embodiment, 28 keys and a three-position SOUND switch 23 are provided on the exterior of the case (see FIG. 1), in communication with the electronics of the interior (FIG. 3). The keys and the switch together constitute a user input system by which the operation of the learning aid is controlled and responses to questions are received. Of course, SOUND switch 23 can be replaced, if desired, by a single toggle key to provide simple sound-ON and sound-OFF capability. It should also be realized that user input can alternatively be made by means of a stylus and a touch-sensitive pad. Such input systems in the personal digital assistant art are well-known. A stylus input system is contemplated as being the equivalent of the keyboard input system described herein. These elements are illustrative only. Any suitable user input system may be used with the display and method of the present invention.

Switch 23 is horizontally-oriented, and, from left to right, its three positions are: OFF, LOW, and HIGH. It controls the output of a speaker (not shown) inside case 10 and the output of any earphones that are plugged into an earphone jack 65 located on the right edge of the exterior of case 10 and shown in FIG. 1. In the alternative the speaker could be replaced by a piezoelectric transducer. Again, all these elements are illustrative only.

The keys are, in general, assigned as follows, as more accurately and fully explained further below:

Ten single-digit number keys 12 enter answers and other numeric input relating to certain below-described ancillary functions, the keys being arranged horizontally from left to right in the order of 1, 2, 3, 4, 5, 6, 7, 8, 9, and 0.

ON/OFF key 24 changes the learning aid from a standby-power-on state to a main-power-on state and vice-versa.

PRACTICE key 13 selects a Practice learning mode.

TEST key 14 selects a Test learning mode.

FLASHCARDS key 15 selects a Flashcards learning mode and performs an ancillary function discussed in the aforementioned application Ser. No. 10/083,455.

TABLE-IN-ORDER key 16 selects a Table-In-Order learning mode.

TABLE-NO-ORDER key 17 selects a Table-No-Order learning mode.

SPECIAL PROBLEMS key 18 selects a Special Problems learning mode.

TIME LIMIT key 19 selects: a per-activity (i.e., per-set-of-problems) time limit if the Practice, Test or Special Problems learning mode is selected, and a per-problem time limit if the Flashcards learning mode is selected.

+ − × ÷ key 20 selects among the arithmetic operations of addition, subtraction, multiplication, and division if any learning mode, other than the Special Problems learning mode, is selected or if the Enter Problems function, is being used.

LEVEL # OR TABLE # key 21 selects under appropriate circumstances among nine levels for each of the four arithmetic operations in connection with the Practice, Test or Flashcards learning mode and among 10 addition tables, 10 subtraction tables, 13 multiplication tables, and 12 division tables in connection with the Table-In-Order or Table-No-Order learning mode.

PAUSE key 25 pauses or restarts the presentation of problems and the counting down of the time limit when the Practice or the Special Problems learning mode is selected, and performs two ancillary functions discussed in the aforementioned application.

START key 22 starts the presentation of problems and also restarts the presentation of problems paused by PAUSE key 25.

HIDE OR SHOW COUNTDOWN key 26 prevents or allows the displaying of the counting down of a per-activity or per-problem time limit and performs two ancillary functions discussed in the aforementioned application.

ERASE MISSED OR ENTERED PROBLEMS key 27 erases all problems stored in volatile memory, whether they are missed problems or entered problems.

ENTER PROBLEMS key 28 initiates and finalizes the process of entering into memory problems to be presented in the entered-problems aspect of the Special Problems mode.

SEE RESULTS key 29 causes display 11 to display information about past efforts to answer problems.

ERASE RESULTS key 30 erases all information stored in memory about past efforts to answer problems.

PROBLEM FORMAT key 31 selects the format of problems being presented and performs two ancillary functions discussed in the aforementioned application.

All the keys preferably are made of hard plastic. The PRACTICE, TEST, FLASHCARDS, TABLE-IN-ORDER, TABLE-NO-ORDER, and SPECIAL PROBLEMS keys are yellow, and the SEE RESULTS and START keys are green. The green color of the START key signifies its “starting” function. Display 11 has a reflector (not shown) which is mostly very light gray in color, but portions of the reflector are yellow and green to link information displayed above them thematically with the just-specified yellow keys and the green SEE RESULTS key.

HIDE OR SHOW COUNTDOWN key 26, ERASE MISSED OR ENTERED PROBLEMS key 27, ERASE RESULTS key 30, and PROBLEM FORMAT key 31 (the four small recessed keys) are all recessed below the surface of the top of case 10 to lessen the possibility of inadvertent activation. ON/OFF key 24 is similarly recessed for the same reason.

The keys and their functions are described herein only for purposes of completeness. As will be apparent below, any conventional input system could also be used with the display and method of the present invention.

The preferred embodiment uses for its question engine a Sunplus SPL31A integrated chip 67 (FIG. 3) made by Sunplus Technology Co., Ltd., Taiwan, which is an eight-bit complementary metal oxide semiconductor (CMOS) single-chip microprocessor which includes: 160 bytes of random access memory, 64 kilobytes of read only memory, seven input ports, 12 general purpose input or output ports, an interrupt or wakeup controller, a built-in 32.768 kilohertz oscillator circuit for real clock function, two 16-bit timers or counters, a power down mode, two eight-bit pulse-width-modulation audio outputs supporting two sound channels, and an automatic display controller and driver for an LCD. Obviously, this chip is just one example of a suitable integrated circuit chip that can be used for the invention. Other embodiments could use other integrated circuit chips or combinations of a plurality of such chips. An example of such an embodiment is the use of a second integrated circuit to manage the keyboard. This second integrated circuit could be an additional SPL31A or some other similar type integrated circuit.

The Sunplus SPL31A chip is programmed with an assembly code program written with the custom software provided by the above-named manufacturer of the chip for the programming of that chip. The various steps performed by the program are set forth in the aforementioned U.S. application Ser. No. 10/083,455. Of course the program instructions to perform those steps will vary depending upon the particular processor used. Preparation of such a program is well within the skill of one of ordinary skill in the art of programming microprocessor devices, and so is not described in detail herein. No invention is claimed in the particular programming steps unique to the Sunplus SPL31A microprocessor.

FIG. 3 is a block diagram of the functional components of the learning aid. The interaction of the various components of learning aid 8 is described in detail in the aforementioned application Ser. No. 10/083,455. In summary the question engine or microprocessor 67 is suitably connected to the two “AA” batteries 71 to provide power to the device. Although only the connection to the microprocessor is explicitly shown, it should be understood that the batteries provide the power for all the electronic components shown, including the memories, the display and the speaker. Microprocessor 67 receives user input information via keys 68, which constitute all the keys shown on the face of the unit in FIG. 1. Basic output is provided to display 11 (for visual output) and a speaker 9 (for aural output). (It should be understood that the speaker is physically located inside the case as the location indicated in FIG. 1 by reference numeral 9.) The present invention may, of course, omit speaker 9 or any other aural output if desired. Microprocessor 67 has both volatile memory 69 and long-term memory 70. Although these are shown as physically separate from the microprocessor, it should be understood that memory of either type could be incorporated into the microprocessor itself. The actual location and form of the memory is not critical. It should also be understood that various interface devices may or may not be included between the microprocessor and the other components shown in FIG. 3 depending upon the particular components being used. The particular interfaces used are of no importance to this invention.

Problems are displayed in the vertically-central, horizontal portion (the problem portion) of display 11 (FIG. 2). For purposes of this invention, problems displayed are in the normal horizontal format, namely a specified first (left) operand, a specified operator (+, −, ×, or ÷), a specified second (right) operand, and a representation of a ? in the normal space for the answer. The problems are displayed in “digit-dedicated” fashion in which the possible positions for the digits comprising the operands and the answer are fixed—as opposed to a display system such as a dot-matrix system in which the digits may be displayed as desired anywhere in the matrix.

### Display Placement When a Learning Activity is in Progress:

As illustrated in FIG. 2, across the problem portion of display 11, there are nine horizontally-arranged array spaces for large digits. Below these spaces are referred to, from left to right, as S1, S2 . . . S9. That is, display 11 includes, in this example, arrays S1-S9, divided into three sets of arrays. The first set of arrays is made up of arrays S1-S3, each of which arrays can display one digit of the left operand. The second set of arrays is made up of arrays S4-S6. Array S6 is used only (in conjunction with others of the nine digit-dedicated arrays in the problem portion of the display when neither a problem nor an equation is being displayed) to display results of work previously performed by the user as explained in the aforementioned U.S. patent application. Since array S6 is located to the left of the “=” symbol 32 on the display 11, one and two-digit right operands are not displayed as far to the right as physically possible. Instead, single digit right operands are displayed in array S5, not array S6, and two-digit right operands are displayed in arrays S4 and S5, not arrays S5 and S6. This is another example of non-right justification of operands. The third set of arrays is made up of arrays S7-S9, each of which arrays can display one digit of a numeral normally representing the answer to the question and comprising one, two or three digits.

In general, in the present invention, each array set includes at least one array having at least seven electronically operable segments, each of said segments being visually continuous, and at least two of the segments for each such array being elongate and oriented in substantially different directions. At least one of the sets of arrays includes at least two arrays so as to display at least two digits side by side, as shown. It should be appreciated that one or more sets of arrays could also include an additional array that does not have the segments as described above (such as a two-segment array for displaying only the numeral “1”).

When appropriate, a representation of a “?” may be displayed in arrays S2, S5, or S9 (not S8). The ? is represented by displaying: (1) the five LCD segments normally used to display the digit 2 minus the horizontal segment normally used to display the base of the 2, and (2) a rectilinear dot-like LCD segment located below the lower end of the segment representing the vertical stem of the 2. (FIG. 2)

When learning activities are in progress, problems are presented as follows:

1. In the left-operand spaces, single-digit operands are displayed in array S2, two-digit operands are displayed in arrays S1 and S2, and three-digit operands are displayed in S1, S2 and S3. That is, display of the operands are not right-justified. Rather than display single digits in array S3 (in the conventional right-justified manner), single digits are displayed in the middle array S2 to improve legibility and appearance. Similarly, the two digit operands are not displayed in a right-justified manner either. They are displayed in arrays S1 and S2, rather than in arrays S2 and S3.

2. In the right-operand spaces, single-digit operands are displayed in array S5, and two-digit operands are displayed in arrays S4 and S5. The second set of arrays is made of arrays S4-S6. Each of arrays S4 and S5, as described, can display one digit of the right operand. (Array S6 is used to display other information when a problem or equation is not being displayed). Note that this is another example of non-right justification of operands. Single digit operands are displayed in array S5, not array S6. Two digit operands, moreover, are displayed in arrays S4 and S5, not arrays S5 and S6.

3. The present invention does not require, however, that all parts of the display display numerals in a non-right justified manner. For example, when the user is asked to enter a left or right operand as an answer, then, in the location where normally answers appear, single-digit numbers are displayed in S9, two-digit numbers in S8 and S9, and three-digit numbers in S7, S8 and S9, which of course is a right-justified display.

The same right-justification display is used for entering regular answers in the third set (arrays S7-S9). That is, if desired, answers are displayed in right-justified fashion as follows:

a. Single-digit numbers appear in S9.

b. When the left digit of a two-digit answer is typed, it first appears in S9, but when the right digit of that two-digit number is typed, the right digit appears in S9 and the left digit moves to S8.

c. When the leftmost digit of a three-digit number is typed, it first appears in S9, and when the middle digit of the three-digit number is typed, that middle digit appears in S9, and the leftmost digit moves to S8, and finally when the rightmost digit of the three-digit number is typed, the rightmost digit appears in S9, the middle digit moves to S8, and the leftmost digit moves to S7.

On the other hand, if desired for purposes of balance and the like, the same non-right justification positioning can be used in the third set of arrays (S7-S9), in which case a one digit answer would be displayed in array S8, for example.

In entering answers in the right-operand location, the preferred method is as follows:

a. Single-digit numbers appear in S5.

b. When the left digit of a two-digit number is typed, it first appears in S5, but when the right digit of that two-digit number is typed, the right digit appears in S5 and the left digit moves to S4. (Note that both “a” and “b” are examples of non-right justification.)

c. There are no three-digit right operands.

In entering answers in the left-operand location, the learning aid first determines whether the correct answer consists of three digits or not.

a. If the correct answer consists of fewer than three digits, the entered number is displayed as follows. Single-digit numbers appear in S2. When the left digit of a two-digit number is typed, it first appears in S2, but when the right digit of that two-digit number is typed, the right digit appears in S2 and the left digit moves to S1. (This is another example of non-right justification.)

b. If the correct answer consists of three digits, when the leftmost digit is typed, it first appears in S3, but when the middle digit is typed, the middle digit appears in S3, and the leftmost digit moves to S2, and finally when the rightmost digit is typed, the rightmost digit appears in S3, the middle digit moves to S2, and the leftmost digit moves to S1.

Although the non-right justification feature of the present invention has been described above in connection with the displaying of problems and with the displaying of answers entered in response to problems (whether the answer be an operand or a sum, difference, product, or quotient), it is not so limited. It can also be used in connection with entering problems. When the Enter Problems function is being used, the display appears as follows:

1. In the left-operand spaces (array set composed of arrays S1, S2, & S3), the first digit entered appears in array S2. If a second digit is entered, that second digit appears in array S2 and the first digit moves to array S1. If a third digit is entered, that third digit appears in array S3 and the other digits do not move. (Thus, when the Enter Problems function is being used, the left operand is non-right justified since when the left operand consists of only one or two digits, the learning aid does not use the rightmost of the three arrays that could have been programmed to physically display the rightmost digit of the left operand.)

2. In the case of the right operand (in the second array set composed of arrays S4, S5, & S6), the first digit entered appears in array S5. If a second digit is entered, that second digit appears in array S5, and the first digit moves to array S4. (This is another example of non-right justification of operands since the right operand is not being displayed as far to the right as physically possible given the location of array S6 to the right of array S5 and to the left of the “=” symbol.)

3. A “?” is always displayed in array S9, except when ENTER PROBLEMS key 28 is pushed after the entering of an appropriate right operand, in which event the answer to the problem being entered is displayed in array S9 if the answer consists of one digit, in array S8 and array S9 if the answer consists of two digits, and in arrays S7, S8, and S9 if the answer consists of three digits. Note that this is an example of right-justification. If desired, non-right justification can be (but is not required to be) applied to the third array set (arrays S7-S9) as well, in which case a single-digit answer would be displayed in array S8, for example.

As previously stated, the question engine functions of the learning aid are implemented in an assembly program that controls the learning aid's above-described Sunplus SPL31A microprocessor.

The non-right justification feature of the present invention has been described above in connection with a device having a great number of input keys. The present invention is not limited in that respect. In general, fewer or more keys and switches could be used depending upon, among other things, the number of functions incorporated in the apparatus. For example, as shown in FIG. 4, the present invention can be used in connection with a much simpler device.

FIG. 4 shows a top view of a battery-powered, integrated-chip-based electronic calculator and learning aid that calculates and teaches arithmetic tables, more specifically, the one hundred basic addition equations from 0+0=0 through 9+9=18; the one hundred basic subtraction equations from 0−0=0 through 18−9=9; the one hundred basic multiplication equations from 0×0=0 through 9×9=81; and the ninety basic division equations from 0÷1=0 through 81÷9=9.

The electronic calculator and learning aid has a case 128 that, in one embodiment, is approximately ten cm wide, ten cm high, and two cm thick. Centered horizontally in the upper portion of the front of case 128 is an LCD 129 that is approximately 7.6 cm wide and two cm high. Spanning LCD 129 from left to right are a first matrix-eight numerical character array 131 configured in the familiar seven-segment design; a second seven-segment array 132; a 13-segment array 130 similar to that shown in FIG. 2 for visually representing either an addition symbol, a subtraction symbol, a multiplication symbol, a division symbol, or a combination of all thirteen segments as a composite symbol; a third seven-segment array 133; an “=” symbol 136; a fourth seven-segment array 134; and a fifth seven-segment array 135. (13-segment array 130 is preferably somewhat larger than shown in FIG. 4.)

The following keys are located on the top of case 128 below LCD 129. Farthest to the right in a vertical column are, beginning at the top: an ON key for turning the device on; an OFF key for turning the device off; and a START key for starting the presentation of a set of 50 problems when the device is on. Immediately to the left of these three keys, arranged in a vertical column, are: a + key for designating the arithmetic operation of addition; a − key for designating subtraction; and a × key for designating multiplication. Below the × key is a ÷ key for designating division. Also on the top of case 128 arranged in the three-by-three pattern normally found on calculators are the “1”, “2”, “3”, “4”, “5”, “6”, “7”, “8”, and “9” keys for entering the nine designated digits. A “0” key for entering the digit 0 is located below the “2” key.

The operation of the device shown in FIG. 4 to help children learn basic math facts is as follows: It is turned on by pushing the ON key. This results in the blinking display of a composite symbol array 130 in LCD 129. If the START key is then pushed, a problem is displayed in LCD 129. Since the composite symbol was blinking when the START key was pushed, the problem is based on one of the three hundred ninety addition, subtraction, multiplication, and division equations taught by the device. The particular equation is selected randomly by device 128, and the problem is presented in a problem format randomly selected by device 128 from one of the following four formats:

1) A format where the first (i.e., left) operand is unknown. This format is indicated by nothing being displayed by either first seven-segment array 131 or second seven-segment array 132. At the same time, the LCD displays a particular arithmetic operator by array 130, a second operand by third seven-segment array 133, “=” symbol 136, and a sum, difference, product, or quotient either by fourth seven-segment array 134 and fifth seven-segment array 135 together (in the case of two-digit answers) or by fourth seven-segment array 134 alone (in the case of one-digit answers). This latter case is an example of non-right justification, since in the right-justification situation a one-digit answer would be displayed in array 135.

2) A format where the arithmetic operator is unknown. This format is indicated by the simultaneous blinking of all of the segments of array 130. At the same time, the LCD displays a first operand by first seven-segment array 131 and second seven-segment array 132 together or by second seven-segment array 132 alone; a second operand by third seven-segment array 133; “=” symbol 136; and a sum, difference, product, or quotient displayed by fourth seven-segment array 134 and fifth seven-segment array 135 together (in the case of two-digit answers) or by fourth seven-segment array 134 alone (in the case of a one-digit answer). Again, the one-digit answer situation is an example of non-right justification of the present invention.

3) A format where the second (i.e., right) operand is unknown. This format is indicated by nothing being displayed by third seven-segment array 133 in conjunction with the displaying of a first operand, a particular arithmetic operator, an “−”, and a sum, difference, product, or quotient.

4) Finally, a format where the sum, difference, product, or quotient is unknown. This format is indicated by nothing being displayed by either fourth seven-segment array 134 or fifth seven-segment array 135 in conjunction with the displaying of a first operand, a particular arithmetic operator, a second operand, and an “=”.

The user then answers the problem displayed by (a) pushing one of the number keys (0, 1, 2, 3, 4, 5, 6, 7, 8, and 9) if the answer is a single-digit number; (b) pushing one of those keys to enter a digit for the tens column and then again pushing one of those keys to enter a digit for the units column if the answer is a two-digit number; and (c) pushing one of the +, −, ×, and ÷ keys if the answer is a particular arithmetic operation.

If the user pushes an inappropriate digit, the electronic learning aid emits a negative-sounding noise, such as a buzzer noise, by means of a piezoelectric element or transducer (not shown) and displays another randomly selected problem in a randomly selected format. If the user answers a problem correctly, the unit emits a positive-sounding noise, such as a melodic chime, and displays another randomly selected problem in a randomly selected format. This process continues until the user has attempted to answer 50 problems.

If immediately prior to starting an exercise with the START key, the user pushes either the +, −, ×, or ÷ key, the unit will operate the same way with two exceptions. First, the equations randomly selected will all be in the selected arithmetic operation, and second, the problem format where the arithmetic operation is unknown will not be selected.

Finally, if the device shown in FIG. 4 is on, pushing the OFF key will turn it off.

Of course, unit 128 may also be used as a calculator. The operation of the device shown in FIG. 4 as a calculator of basic math facts is as follows: The user turns it on by pushing the ON key. This results in the blinking display of a composite operator, namely all segments of array 130 in LCD 129. If the user then pushes a number key, the appropriate digit (the first digit) is displayed by second seven-segment array 132 and nothing else changes. If the user then pushes a number key, if the first digit and the digit corresponding to the just-pushed number key (the second digit) in that order do not together constitute the left operand of one of the aforementioned 390 math facts that the device teaches (the 390 facts), then the device emits a negative noise and nothing else changes, but if, on the other hand, the first digit and the second digit in that order do together constitute the left operand of one of the 390 facts, then the first digit and the second digit are displayed by first and second seven-segment arrays 131 and 132, respectively. In either event, if the user then pushes one of the +, −, ×, and ÷ keys, then if the currently displayed one or two-digit left operand and the corresponding arithmetic operator constitute the left operand and operator of one of the 390 facts, that operator is displayed by array 130. If not, the device emits a negative noise and nothing else happens, in which case the user can push a different one of the +, −, ×, and ÷ keys until the displayed left operand and the corresponding operator constitute the left operand and operator of one of the 390 facts. Then the user can push a number key. If the corresponding number, the displayed left operand, and the displayed operator constitute the right operand, the left operand, and the operator of one of the 390 facts, then that corresponding number is displayed by third seven-segment array 133, and if not, the device emits a negative noise, in which case the user can push one or, if necessary, more number keys until a number corresponding to a pushed key, the displayed left operand, and the displayed operator do constitute the right operand, the left operand, and the operator of one of the 390 facts resulting in that corresponding number being display by array 133. If the user then pushes the START key, the answer to the displayed problem is displayed in the fourth and fifth seven-segment arrays 134 and 135 if the answer has two digits and in the fourth array 134 if the answer has only one digit. Then pushing the START key again clears all the seven-segment arrays and causes all segments of the array 130 to start blinking, just as if the device had been just turned on with the ON key. Again, pushing the OFF key turns the device off.

Of course, the displaying of a single-digit answer in array 134, as opposed to array 135, by the device shown in FIG. 4 when it is being used as a calculator is an example of non-right justification of the present invention.

Although the description above contains many specifics, these should not be construed as limiting the scope of the invention but as merely providing illustrations of some of the currently preferred embodiments of the invention. There are numerous variations or modifications that can be incorporated into other embodiments of the learning aid and that are known to and within the understanding of persons skilled in the art. The scope of the invention should be determined by the appended claims and their legal equivalents, rather than by the examples given. It should be understood that the examples given above are illustrative only and are not to be taken as limitations on the scope of the present invention.

1. A method of visually representing arithmetic equations on a display, one at a time, each of the equations comprising (a) a left operand comprising at least one digit, (b) an arithmetic operator located to the right of the left operand and selected from the group consisting of an addition symbol, a subtraction symbol, a multiplication symbol, and a division symbol, (c) a right operand located to the right of the operator and comprising at least one digit, (d) an equal symbol located to the right of the right operand, and (e) a numeral located to the right of the equal symbol, said numeral comprising at least one digit and representing a member of a set consisting of a sum, a difference, a product, and a quotient, said left operand, said right operand, and said numeral each constituting a term of an equation to be displayed, the method comprising:
simultaneously displaying at least one digit of the left operand in a first set of separate arrays, at least one digit of the right operand in a second set of separate arrays, and at least one digit of the numeral in a third set of separate arrays, each of said arrays being located in a separate fixed position on the display essentially horizontally to the left or right of each other array and comprising at least seven electronically operable segments, each segment being visually continuous, at least two of the segments for each array being elongate and oriented in substantially different directions, each of the sets of arrays having at least one array and at least one of the sets of arrays including at least two arrays so as to display at least two digits side by side;
for at least a first equation, displaying a rightmost digit of one of the terms in one of the arrays, which array is used for a different, second equation to display a second-to-rightmost digit of the corresponding term of the second equation, said corresponding term in the second equation comprising at least one more digit than the corresponding term in the first equation.

2. The method as set forth in claim 1 wherein the corresponding term of the first equation is the left operand.

3. The method as set forth in claim 2 wherein the equations are displayed on an electronic learning aid.

4. The method as set forth in claim 1 wherein the corresponding term of the first equation is the right operand.

5. The method as set forth in claim 1 wherein the corresponding term of the first equations is the numeral.

6. The method as set forth in claim 5 wherein the equations are displayed on an electronic learning aid.

7. The method as set forth in claim 1 wherein, for at least two of the first equation's left operand, right operand, and numeral, the rightmost digit is displayed in an array which is used to display the second-to-rightmost digit of the corresponding term of the second equation.

8. The method as set forth in claim 1 wherein at least one seven-segment array is used to display a digit of a term of an equation.

9. The method as set forth in claim 1 wherein the equations are displayed on an electronic learning aid.

10. The method as set forth in claim 1 wherein all the arrays use LCD technology.

11. The method as set forth in claim 1 wherein the equations are displayed on an electronic learning aid and all the arrays use LCD technology.

12. (canceled)

13. (canceled)

14. A method of visually representing an arithmetic equation on a display, said equation having (a) a left operand comprising at least one digit, (b) an arithmetic operator located to the right of the left operand and selected from the group consisting of an addition symbol, a subtraction symbol, a multiplication symbol, and a division symbol, (c) a right operand located to the right of the operator and comprising at least one digit, (d) an equal symbol located to the right of the right operand, and (e) a numeral located to the right of the equal symbol, said numeral comprising at least one digit and representing a member of a set consisting of a sum, a difference, a product, and a quotient, said left operand, said right operand, and said numeral each constituting a term of the equation to be displayed, the method comprising:
displaying the left operand in a first set of separate arrays, said first set of separate arrays having at least one array;
displaying the right operand in a second set of separate arrays, said second set of separate arrays having at least one array;
displaying the numeral in a third set of separate arrays, said third set of separate arrays having at least two arrays capable of displaying two digits side-by-side;
each or said arrays being located in a separate fixed position on the display essentially horizontally to the left or right of each other array and comprising at least seven electronically operable segments, each segment being visually continuous, at least two of the segments for each of said arrays being elongate and oriented in substantially different directions;
wherein at least one of the left operand, the right operand, or the numeral contains fewer digits than the number of such arrays in the corresponding array set, the rightmost array in said corresponding array set being inactive during display of the equation.

15. The method as set forth in claim 14 wherein the equation is displayed on an electronic learning aid.

16. (canceled)

17. (canceled)

18. The method as set forth in claim 15 wherein the corresponding array set corresponds to the left operand and wherein all the arrays use LCD technology.

19. The method as set forth in claim 15 wherein the corresponding array set corresponds to the numeral and wherein all the arrays use LCD technology.

20. A method of visually representing an arithmetic equation on a display, said equation having (a) a left operand comprising at least one digit, (b) an arithmetic operator located to the right of the left operand and selected from the group consisting of an addition symbol, a subtraction symbol, a multiplication symbol, and a division symbol, (c) a right operand located to the right of the operator and comprising at least one digit, (d) an equal symbol located to the right of the right operand, and (e) a numeral located to the right of the equal symbol, said numeral comprising at least one digit and representing a member of a set consisting of a sum, a difference, a product, and a quotient, said left operand, said right operand, and said numeral each constituting a term of the equation to be displayed, the method comprising:
displaying the left operand in a first set of separate arrays, said first set of separate arrays having at least one array;
displaying the right operand in a second set of separate arrays, said second set of separate arrays having at least one array;
displaying the numeral in a third set of separate arrays, said third set of separate arrays having at least two arrays capable of displaying two digits side-by-side;
each of said arrays being located in a separate fixed position on the display essentially horizontally to the left or right of each other array and comprising at least seven electronically operable segments, each segment being visually continuous, at least two of the segments for each of said arrays being elongate and oriented in substantially different directions;
wherein at least one of the terms of the equation is displayed non-right justified.

21. The method as set forth in claim 20 wherein the equation is displayed on an electronic learning aid.

22. The method as set forth in claim 21 wherein the corresponding array set corresponds to the left operand.

23. The method as set forth in claim 21 wherein the corresponding array set corresponds to the numeral.

24. (canceled)

25. (canceled)

26. (canceled)

27. The display system as set forth in claim 26 wherein the equations are displayed on an electronic learning aid.

28-32. (canceled)

33. The display system as set forth in claim 27 wherein all said arrays use LCD technology.

34-41. (canceled)

42. A display system for visually representing an arithmetic equation, said equation having (a) a left operand comprising at least one digit, (b) an arithmetic operator located to the right of the left operand and selected from the group consisting of an addition symbol, a subtraction symbol, a multiplication symbol, and a division symbol, (c) a right operand located to the right of the operator and comprising at least one digit, (d) an equal symbol located to the right of the right operand, and (e) a numeral located to the right of the equal symbol, said numeral comprising at least one digit and representing a member of a set consisting of a sum, a difference, a product, and a quotient, said left operand, said right operand, and said numeral each constituting a term of the equation to be displayed, said display system comprising:
a first set of separate arrays capable of displaying the left operand, said first set of separate arrays having at least one array;
a second set of separate arrays capable of displaying the right operand, said second set of separate arrays having at least one array;
a third set of separate arrays capable of displaying the numeral, said third set of separate arrays having at least two arrays capable of displaying two digits side-by-side;
each array being located in a separate fixed position on the display system essentially horizontally to the left or right of each other array and comprising at least seven electronically operable segments, each segment being visually continuous, at least two of the segments for each array being elongate and oriented in substantially different directions;
an electronic control system which causes the non-right justified display of at least one of the terms of the equation, whereby the arithmetic operator, the equal symbol, and all the digits of said equation appear better visually-balanced to a human observer.

43. The display system as set forth in claim 42 wherein the equation is displayed on an electronic learning aid.

44-48. (canceled)

49. The display system as set forth in claim 43 wherein all said arrays use LCD technology.
